(19) United States
(12) Patent Application Publication
(10) Pub. No.: US 2017/0276623 A1
(43) Pub. Date: Sep. 28, 2017

(54) BALER WITH AUTOMATED MOISTURE MEASUREMENT AND PRESERVATIVE APPLICATION

(71) Applicant: AGCO Corporation, Hesston, KS (US)

(72) Inventors: Lawrence Grant MacNeill, Suwanee, GA (US); Patrick Kendrick, Hesston, KS (US); Maynard M. Herron, Hesston, KS (US); Shane Bollinger, Hesston, KS (US); Lawrence D. RETZLAFF, Hesston, KS (US)

(21) Appl. No.: 15/505,657

(22) PCT Filed: Sep. 1, 2015
(86) PCT No.: PCT/US2015/047961

§ 371 Date: Feb. 22, 2017

Related U.S. Application Data
(60) Provisional application No. 62/045,702, filed on Sep. 4, 2014.

(51) Int. Cl. G01N 27/04; A01F 15/07; G01N 27/60; A01F 15/08

(52) U.S. Cl. CPC G01N 27/048; A01F 15/0825; A01F 15/0715; G01N 27/605; A01F 2015/076

(57) ABSTRACT

A system for determining an amount of and applying a preservative to an individual charge of crop material, wherein the charge is combined with other charges to form a bale. Loose crop material is collected and packed into a feeder chute in such a manner as to pre-compress the material to form the charge. A moisture content of the charge is measured by a sensor while the charge is still in the feeder chute. The charge is moved into a forming chamber, and a control unit determines a correct amount of a preservative to apply to the charge based on the moisture content. The correct amount of the preservative is applied to the charge either before or after the charge is incorporated into the bale. Thus, the system measures the moisture content of each charge, and measures the moisture content of the same charge to which the preservative is applied.

### CROSS REFERENCE TO RELATED APPLICATION

This application claims the benefit of U.S. Provisional Application No. 62/045,702, filed Sep. 4, 2014, which is hereby incorporated by reference in its entirety.

### FIELD

The present invention relates to systems and methods for controlling the operation of balers.

### BACKGROUND

Large square balers are used in the agricultural industry to create large substantially rectangular bales of crop material by moving over crop windrows to collect loose crop material, compress it, and form it into bales that are then tied and ejected. To that end, a baler is typically mechanically coupled with a tractor, and a power take-off (PTO) mechanism transfers power from the tractor's engine to drive the baler's operation. A rotary pick-up at the front of the baler collects the loose crop material and moves it into a feeder chute. Once the feeder chute is full, its contents are moved into a forming chamber. A reciprocating plunger compresses the crop material in the forming chamber into a growing bale. Once the bale reaches a predetermined length, which could be eight feet, it is tied and ejected through a discharge outlet to fall onto the ground behind the baler. The process then continues to create the next bale.

A sensor may be used to measure a moisture content of the crop material, and an amount of a preservative may be applied to the crop material based on the measured moisture content. However, the system measures the moisture content of crop material that has already been compressed into the bale, and applies the corresponding amount of preservative to loose crop material entering the baler's feeding system. This creates a lag between measuring moisture content and applying preservative, and this lag can correspond to tens or hundreds of feet of windrow distance, over which moisture content can vary greatly.

Furthermore, moisture content is determined using a conductivity sensor that measures electrical conductivity between two contact points on opposite sides of the bale or spaced-apart on one side of the bale. These contact points are located some distance behind the last crop material added to the bale, which prevents precise application to the specific portion of the bale needing treated. The amount of preservative is adjusted for the maximum moisture content measured over some time and volume interval, and the preservative is then applied to the entire stream of crop material entering the baler, which provides no opportunity to adjust for abrupt changes in moisture content and can therefore result in over-application of the preservative.

This background discussion is intended to provide information related to the present invention which is not necessarily prior art.

### SUMMARY

Embodiments of the present invention solve the above-described and other problems and limitations by providing a baling system that measures the moisture content of each individual charge rather than the entire bale, and that measures the moisture content of the same charge to which the preservative is applied, and thereby more accurately determines the correct amount of preservative, which minimizes both wastage of the preservative and risk of subsequent deterioration of the bale.

In an embodiment of the present invention, a baling system may be operable to receive loose material, form the loose material into an individual charge, and compress the individual charge with one or more other charges to form a bale. Broadly characterized, the baling system may comprise the following. A feeder component may be operable to pre-compress the loose material to form the individual charge and then move the individual charge into a forming chamber, and may include a feeder chute having a feeder chute outlet connected to the forming chamber, one or more packing forks that extend into the feeder chute and are operable to pack the loose material into the feeder chute in such a manner as to pre-compress the loose material to form the individual charge, and a stuffer fork operable to move the pre-compressed individual charge into the forming chamber via the feeder chute outlet. A moisture sensor may be operable to determine a moisture content of the individual charge in the feeder chute. A preservative application component may be operable to apply a preservative to the individual charge in the forming chamber. A control unit may be in communication with the moisture sensor and the preservative application component, and may be operable to receive an input signal from the moisture sensor regarding the moisture content of the individual charge when the charge is in the feeder chute, determine a correct amount of the preservative based on the moisture content, and send an output signal to cause the correct amount of the preservative to be applied to the individual charge when the individual charge is in the forming chamber.

In various implementations of this first embodiment, the baling system may further include any one or more of the following additional features. The moisture sensor may be a near infra-red sensor operable to use near infra-red radiation to determine the moisture content, and the near-infra-red sensor may be operable to determine a first moisture content at a first point on the individual charge and a second moisture content at a second point on the individual charge, wherein the first moisture content and the second moisture content are averaged to represent the moisture content of the individual charge. The moisture sensor may be a microwave sensor operable to use microwave radiation to determine the moisture content. The microwave sensor may determine a free water content of the individual charge, wherein the free water content is correlated with a mass of the individual charge. The moisture sensor may determine the moisture content of the individual charge immediately prior to the individual charge being moved into the forming chamber. The preservative application component may include a reservoir for holding the preservative; a pump module for pumping the preservative out of the reservoir, and one or more spray nozzles for releasing the pumped preservative into the forming chamber so as to at least partially cover at least one surface of the individual charge. The baling system may further including a plunger operable to move in a reciprocating manner within the forming chamber from a front-dead-center position in which the plunger is furthest from the bale to a rear-dead-center position in which the plunger is closest to the bale, wherein the feeder component is operable to pre-compress the loose material into the individual charge and then move the individual charge into the forming chamber for compression by the plunger into the bale.

Additionally, each of these embodiments and implementations may be alternatively characterized as methods based on their functionalities.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a cross-sectional elevation view of a baling system constructed in accordance with an embodiment of the present invention;

FIG. 2 is a cross-sectional elevation view of a feeder component of an embodiment of the baling system of FIG. 1; and

FIG. 3 is a flow diagram of method steps performed by an embodiment of the baling system of FIG. 1.

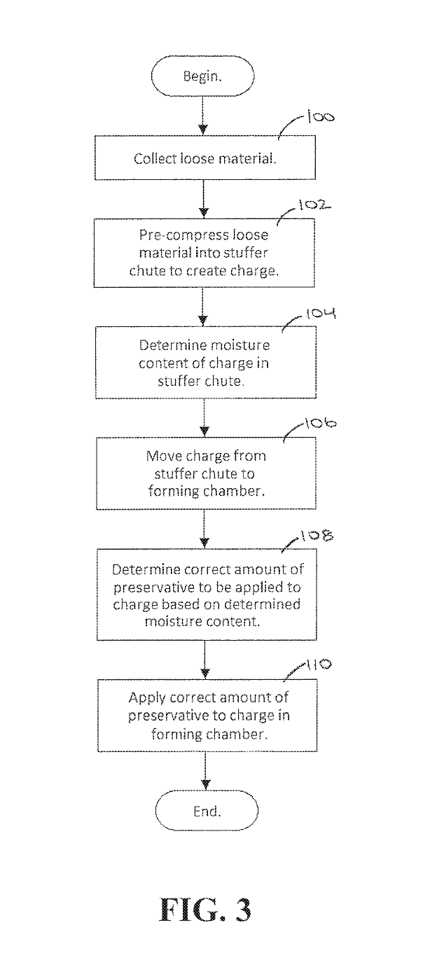

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

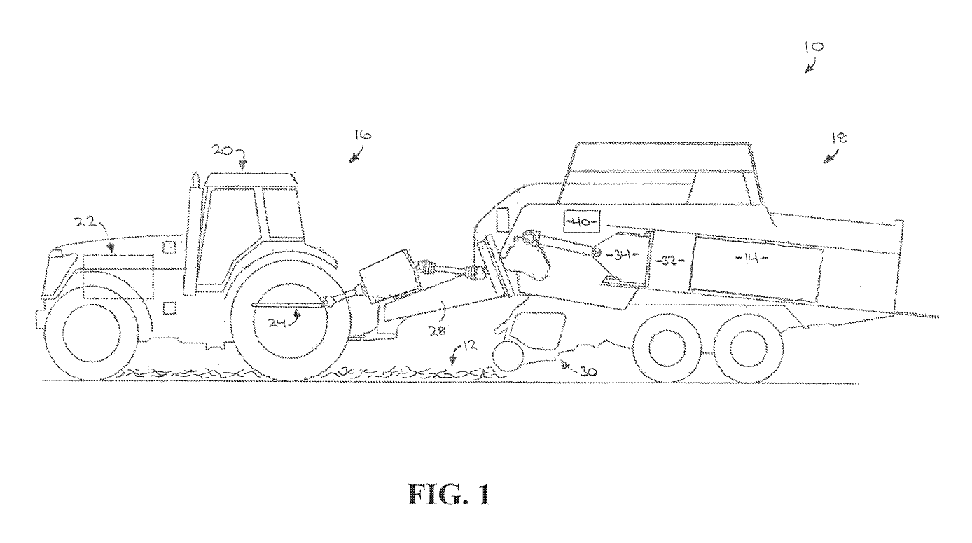

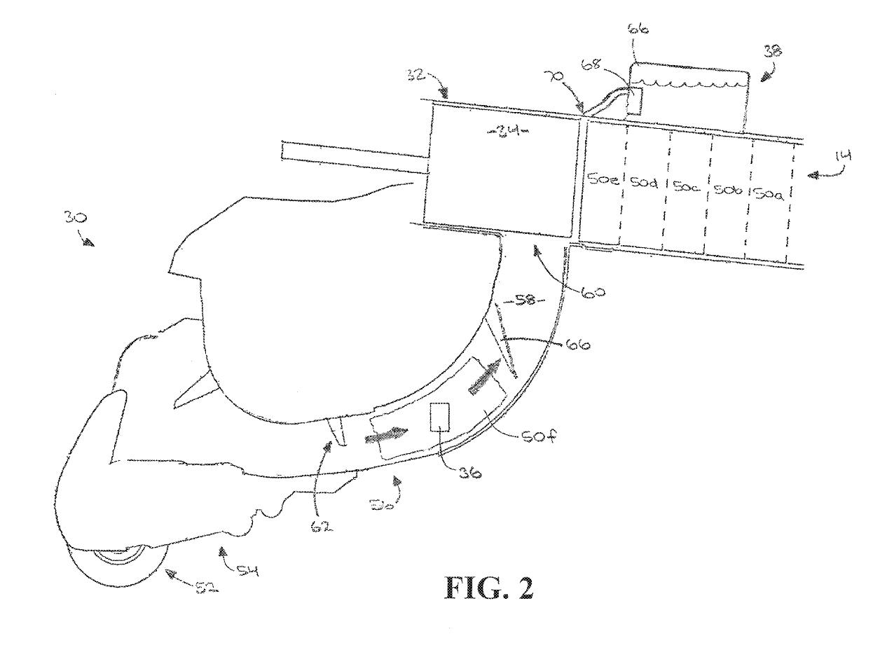

Broadly characterized, the present invention provides a baling system that measures the moisture content of each individual charge of pre-compressed crop material rather than an entire bale, and measures the moisture content of the same charge to which the preservative is applied, and thereby more accurately determines the correct amount of the preservative, which minimizes both wastage of the preservative and risk of subsequent deterioration of the bale. Referring to FIGS. 1 and 2, an embodiment of the baling system 10 is operable to receive loose crop material 12, form it into an individual charge 50f, and compress the individual charge 50f with one or more other charges 50a-e to form a bale 14. The baling system 10 may broadly comprise a tractor 16 and a baler 18. The tractor 16 may include a cab 20 wherein an operator is located; an engine 22 operable to move the tractor 16; and a PTO 24 operable to transfer mechanical power from the engine 22 to the baler 18 or other connected machinery. The baler 18 may broadly comprise a frame 28 mechanically coupled with the tractor 16; a loose crop material receiving and stuffing component 30; a forming chamber 32; a plunger 34; one or more moisture sensors 36; a preservative application component 38; and an electronic control unit (ECU) 40.

The loose crop material receiving and stuffing component 30 may be operable to collect loose crop material 12 from the ground, pre-compress it into individual charges 50a-f (or “flakes”), and move the individual charges 50a-f into the forming chamber 32 for incorporation into the bale 14. The loose crop material receiving and stuffing component 30 may include a collector component 52 operable to pick-up the loose crop material 12 from the ground, a cutter component 54 operable to cut the collected loose crop material 12 into smaller pieces, and a feeder component 56 operable to pre-compress the loose crop material 12 to form the individual charge 50f and then feed the charge 50f into the forming chamber 32. The feeder component 56 may include a feeder chute 58 extending between the collector component 52 (or cutter component 54, if so equipped) and a feeder chute outlet 60 at the forming chamber 32 and through which the loose crop material moves from the former to the latter, one or more packing forks 62 operable to pack the collected loose crop material 12 into the feeder chute 58 in such a manner as to pre-compress the loose crop material 12 into the charge 50f, and a stuffer fork 66 operable to move the pre-compressed charge 50f into the forming chamber 32 via the feeder chute outlet 60.

The forming chamber 32 may be operable to receive the charge 50f so that it can be compressed by the plunger 34 into the bale 14. The forming chamber 32 may be substantially rectangular in shape to facilitate the compression and forming process. The plunger 34 may be operable to compress the charge 50f into the bale 14 by moving within the forming chamber 32 in a reciprocating manner. More specifically, the plunger 34 repeatedly extends into the forming chamber 32 to compress the charges 50a-e that are already present therein, and retracts to allow the next charge 50f to enter the forming chamber 32 via the feeder chute outlet 60.

The one or more moisture sensors 36 may be located in or on an interior surface of the feeder chute 58 and may be operable to determine or provide information to the ECU 40 for determining a moisture content of the charge 50f while it is still in the feeder chute 58. In one implementation, the moisture sensor 36 may be a near infra-red scanner sensor operable to use near infra-red radiation to determine the moisture content of one or more points on the charge 50f. If the moisture content of more than one point is determined, then the results may be averaged to represent the moisture content of the entire charge 50f In another implementation, the moisture sensor 36 may be a microwave sensor operable to use microwave radiation to measure an amount of free water in the charge 50f. The amount of free water in the charge 50f may be correlated with the mass of the charge 50f. The mass of the charge 50f may be estimated based on a weight of the charge 50f, and the weight of the charge 50f may be determined directly or calculated based on the weight of the bale 14 and the known number of charges 50a-e in the bale 14. The density of the charge 50f is highest just before the charge 50f is moved into the forming chamber 32, and the moisture content may be measured at that time.

The preservative application component 38 may be operable to apply a preservative to each of the individual charges 50a-f either before or after the plunger 34 compresses them into the bale 14. The preservative may in liquid, powder, or other form. The preservative application component 38 may include a reservoir 66 for holding the preservative, a pump module 68 for pumping the preservative out of the reservoir 66, and one or more spray nozzles 70 for releasing the pumped preservative into the forming chamber 32 so as to at least partially cover at least one surface of the introduced charge 50a-f. Migration of the preservative within the bale 14 over small distances helps to prevent deterioration of the quality of the bale 14.

The ECU 40 may be operable to receive input signals from the one or more moisture sensors 36 and provide output signals to the various components of the baling system 10, including the preservative application component 38, to substantially automatically accomplish the application of the correct amount of the preservative to each of the individual charges 50a-f before or after they are incorporated into the bale 14.

In operation, the baling system 10 may function as follows. The collector component 52 of the loose crop material receiving and stuffing component 30 collects loose crop material 12 from the ground, as shown in step 100. If the baler 18 is so equipped, the cutter component 54 cuts the collected loose crop material 12 into smaller pieces. The one or more packing forks 62 of the feeder component 56 pack the loose crop material 12 into the feeder chute 58, wherein the feeder chute outlet 60 is covered by the plunger 34 so that packing the loose crop material 12 into the feeder chute 58 pre-compresses it to form the individual charge 50f, as shown in step 102. The one or more moisture sensors 36 located in or on an interior surface of the feeder chute 58 determine or provide information to the ECU 40 for determining the moisture content of the charge 50f while it is still in the feeder chute 58, as shown in step 104. When the plunger 34 moves so as to uncover the feeder chute outlet 60, the stuffer fork 66 of the feeder component 56 moves the pre-compressed charge 50f into the forming chamber 32 via the feeder chute outlet 60, as shown in step 106. The ECU 40 determines the correct amount of the preservative to be applied to the charge 50f based on the determined moisture content of that charge 50f, as shown in step 108, and causes the preservative application component 38 to apply the determined correct amount of the preservative to the charge 50f in the forming chamber, as shown in step 110. As discussed, the application of the preservative can occur before or after the plunger 34 compresses the charge 50f into the other charges already present in the forming chamber 32 to form the bale 14.

It will be appreciated that measuring the moisture content of the charge 50f in the feeder chute 58 is more accurate than measuring the moisture content of the entire bale 14. Furthermore, measuring the moisture content of and applying the corresponding correct amount of the preservative to the same charge 50f is more accurate than measuring the moisture content of a prior charge (e.g., 50e) and applying the corresponding amount of preservative to a subsequent charge (e.g., 50f). Both features allow for making finer adjustments to the amount of applied preservative.

Thus, the present invention provides advantages over the prior art, including that it measures the moisture content of each individual charge rather than the entire bale, and it measures the moisture content of the same charge to which the preservative is applied, and thereby more accurately determines the correct amount of the preservative, which minimizes both wastage of the preservative and risk of subsequent deterioration of the bale.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A baling system operable to receive loose material, form the loose material into an individual charge, and compress the individual charge with one or more other charges to form a bale, the baling system comprising:
a forming chamber;
a feeder component operable to pre-compress the loose material to form the individual charge and then move the individual charge into the forming chamber, the feeder component including a feeder chute having a feeder chute outlet connected to the forming chamber;
a moisture sensor operable to determine a moisture content of the individual charge in the feeder chute;
a preservative application component operable to apply a preservative to the individual charge in the forming chamber; and
a control unit in communication with the moisture sensor and the preservative application component, and operable to receive an input signal from the moisture sensor regarding the moisture content of the individual charge when the charge is in the feeder chute, determine a correct amount of the preservative based on the moisture content, and send an output signal to cause the correct amount of the preservative to be applied to the individual charge when the individual charge is in the forming chamber.

2. The baling system as set forth in claim 1, wherein the moisture sensor is a near infra-red sensor operable to use near infra-red radiation to determine the moisture content.

3. The baling system as set forth in claim 2, wherein the near-infra-red sensor is operable to determine a first moisture content at a first point on the individual charge and a second moisture content at a second point on the individual charge, wherein the first moisture content and the second moisture content are averaged to represent the moisture content of the individual charge.

4. The baling system as set forth in claim 1, wherein the moisture sensor is a microwave sensor operable to use microwave radiation to determine the moisture content.

5. The baling system as set forth in claim 4, wherein the microwave sensor determines a free water content of the individual charge, and the free water content is correlated with a mass of the individual charge.

6. The baling system as set forth in claim 1, wherein the moisture sensor determines the moisture content of the individual charge immediately prior to the individual charge being moved into the forming chamber.

7. The baling system as set forth in claim 1, wherein the preservative application component includes
a reservoir for holding the preservative;
a pump module for pumping the preservative out of the reservoir, and
one or more spray nozzles for releasing the pumped preservative into the forming chamber so as to at least partially cover at least one surface of the individual charge.

8. The baling system as set forth in claim 1, further including a plunger operable to move in a reciprocating manner within the forming chamber from a front-dead-center position in which the plunger is furthest from the bale to a rear-dead-center position in which the plunger is closest to the bale, wherein the feeder component is operable to pre-compress the loose material into the individual charge and then move the individual charge into the forming chamber for compression by the plunger into the bale.

9. The baling system as set forth in claim 1, the feeder component further including:
one or more packing forks that extend into the feeder chute and are operable to pack the loose material into the feeder chute in such a manner as to pre-compress the loose material to form the individual charge; and
a stuffer fork operable to move the pre-compressed individual charge into the forming chamber via the feeder chute outlet;

10. A method of operating a baling system, wherein the baling system includes a feeder chute and a forming chamber and is operable to receive loose material, form the loose material into an individual charge in the feeder chute, and compress the individual charge with one or more other charges to form a bale in the forming chamber, the method comprising the steps of:
(1) collecting the loose material and packing the loose material into the feeder chute in such a manner as to pre-compress the loose material to form the individual charge;
(2) measuring with an electronic sensor mounted in the feeder chute a moisture content of the individual charge while the individual charge is in the feeder chute;
(3) moving the individual charge into the forming chamber;
(4) determining with an electronic control unit a correct amount of a preservative to apply the individual charge based on the measured moisture content of the individual charge; and
(5) applying the determined correct amount of the preservative to the individual charge in the forming chamber.

11. The method as set forth in claim 10, wherein measuring the moisture content of the individual charge is accomplished by a near infra-red sensor operable to use near infra-red radiation to determine the moisture content.

12. The method as set forth in claim 11, wherein the near infra-red sensor measures the moisture content of the individual charge by
determining a first moisture content at a first point on the individual charge; and
determining a second moisture content at a second point on the individual charge,
wherein the first and second moisture contents are then averaged.

13. The method as set forth in claim 10, wherein measuring the moisture content of the individual charge is accomplished by a microwave sensor operable to use microwave radiation to determine the moisture content.

14. The method as set forth in claim 13, wherein the microwave sensor measures the moisture content of the individual charge by determining a free water content of the individual charge, wherein the free water content is then correlated with a mass of the individual charge.

15. The method as set forth in claim 10, wherein the step (2) of measuring the moisture content of the individual occurs immediately prior to the step (3) of moving the individual charge into the forming chamber.

16. The method as set forth in claim 10, further including the step of compressing the individual charge into the bale after performing the step (5) of applying the determined correct amount of the preservative to the individual charge in the forming chamber.

17. The method as set forth in claim 10, further including the step of compressing the individual charge into the bale before performing the step (5) of applying the determined correct amount of the preservative to the individual charge in the forming chamber.

18. A method of operating a baling system, wherein the baling system includes a feeder chute and a forming chamber and is operable to receive loose crop material, form the loose crop material into an individual charge in the feeder chute, and compress the individual charge with one or more other charges to form a bale in the forming chamber, the method comprising the steps of:
(1) collecting the loose crop material and packing the loose crop material into the feeder chute in such a manner as to pre-compress the loose crop material to form the individual charge;
(2) measuring with an electronic sensor mounted in the feeder chute a moisture content of the individual charge while the individual charge is in the feeder chute;
(3) moving the individual charge into the forming chamber, wherein the step (2) of measuring the moisture content of the individual occurs immediately prior to the step (3) of moving the individual charge into the forming chamber;
(4) determining with an electronic control unit a correct amount of a liquid preservative to apply the individual charge based on the measured moisture content of the individual charge; and
(5) applying the determined correct amount of the liquid preservative to the individual charge in the forming chamber.

19. The method as set forth in claim 18, further including the step of compressing the individual charge into the bale after performing the step (5) of applying the determined correct amount of the liquid preservative to the individual charge in the forming chamber.

20. The method as set forth in claim 18, further including the step of compressing the individual charge into the bale before performing the step (5) of applying the determined correct amount of the liquid preservative to the individual charge in the forming chamber.
